(19) United States
(12) Patent Application Publication
(10) Pub. No.: US 2013/0010641 A1
(43) Pub. Date: Jan. 10, 2013

(54) Carrier Activation Employing RRC messages

(76) Inventor: Esmael Dinan, Herndon, VA (US)

(21) Appl. No.: 13/536,981

(22) Filed: Jun. 28, 2012

Related U.S. Application Data
(60) Provisional application No. 61/504,631, filed on Jul. 5, 2011.

(51) Int. Cl. H04W 16/02

(52) U.S. Cl. 370/254

(57) ABSTRACT

A base station transmits an RRC reconfiguration message to an RRC-connected wireless device to configure secondary carrier(s). The RRC reconfiguration message is configured to cause the RRC-connected wireless device to control the activation of at least one secondary carrier. The base station transmits data packets to the RRC-connected wireless device on a data channel on at least one of the secondary carriers.

### CROSS-REFERENCE TO RELATED APPLICATIONS

This application claims the benefit of U.S. Provisional Application No. 61/504,631, filed Jul. 5, 2011, entitled “Carrier Activation Using RRC messages,” which is hereby incorporated by reference in its entirety.

### BRIEF DESCRIPTION OF THE SEVERAL VIEWS OF THE DRAWINGS

Examples of several of the various embodiments of the present invention are described herein with reference to the drawings, in which:

FIG. 1 is a diagram depicting example sets of OFDM subcarriers as per an aspect of an embodiment of the present invention;

FIG. 2 is a diagram depicting an example transmission time and reception time for two carriers as per an aspect of an embodiment of the present invention;

FIG. 3 is a diagram depicting OFDM radio resources as per an aspect of an embodiment of the present invention;

FIG. 4 is a block diagram of a base station and a wireless device as per an aspect of an embodiment of the present invention;

FIG. 5 is a block diagram depicting a system for transmitting data traffic over an OFDM radio system as per an aspect of an embodiment of the present invention;

FIG. 6 is a diagram depicting changes in carrier configuration as per an aspect of an embodiment of the present invention; and

FIG. 7 is a diagram depicting changes in carrier configuration during handover as per an aspect of an embodiment of the present invention.

### DETAILED DESCRIPTION OF EMBODIMENTS

Example embodiments of the present invention employ RRC messages for carrier activation in an OFDM communication system. Embodiments of the technology disclosed herein may be employed in the technical field of wireless communication systems. More particularly, the embodiments of the technology disclosed herein may relate to carrier activation using RRC messages in an OFDM communication system.

Example embodiments of the invention may be implemented using various physical layer modulation and transmission mechanisms. Example transmission mechanisms may include, but are not limited to: CDMA (code division multiple access), OFDM (orthogonal frequency division multiplexing), TDMA (time division multiple access), Wavelet technologies, and/or the like. Hybrid transmission mechanisms such as TDMA/CDMA, and OFDM/CDMA may also be employed. Various modulation schemes may be applied for signal transmission in the physical layer. Examples of modulation schemes include, but are not limited to: phase, amplitude, code, a combination of these, and/or the like. An example radio transmission method may implement QAM (quadrature amplitude modulation) using BPSK (binary phase shift keying), QPSK (quadrature phase shift keying), 16-QAM, 64-QAM, 256-QAM, and/or the like. Physical radio transmission may be enhanced by dynamically or semi-dynamically changing the modulation and coding scheme depending on transmission requirements and radio conditions.

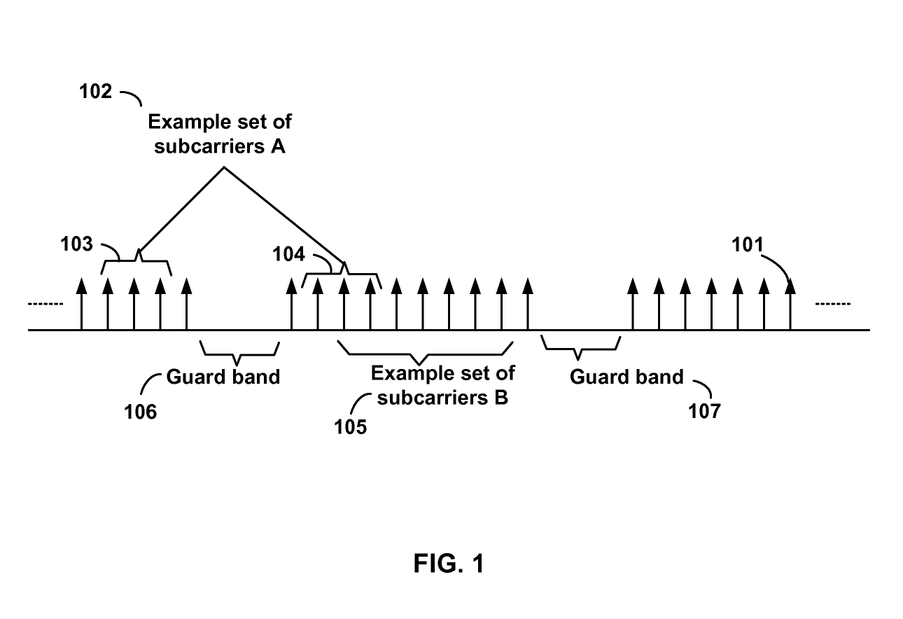

FIG. 1 is a diagram depicting example sets of OFDM subcarriers as per an aspect of an embodiment of the present invention. As illustrated in this example, arrow(s) in the diagram may depict a subcarrier in a multicarrier OFDM system. The OFDM system may use technology such as OFDM technology, SC-OFDM (single carrier-OFDM) technology, or the like. For example, arrow 101 shows a subcarrier transmitting information symbols. FIG. 1 is for illustration purposes, and a typical multicarrier OFDM system may include more subcarriers in a carrier. For example, the number of subcarriers in a carrier may be in the range of 10 to 10,000 subcarriers. FIG. 1 shows two guard bands 106 and 107 in a transmission band. As illustrated in FIG. 1, guard band 106 is between subcarriers 103 and subcarriers 104. The example set of subcarriers A 102 includes subcarriers 103 and subcarriers 104. FIG. 1 also illustrates an example set of subcarriers B 105. As illustrated, there is no guard band between any two subcarriers in the example set of subcarriers B 105. Carriers in a multicarrier OFDM communication system may be contiguous carriers, non-contiguous carriers, or a combination of both contiguous and non-contiguous carriers.

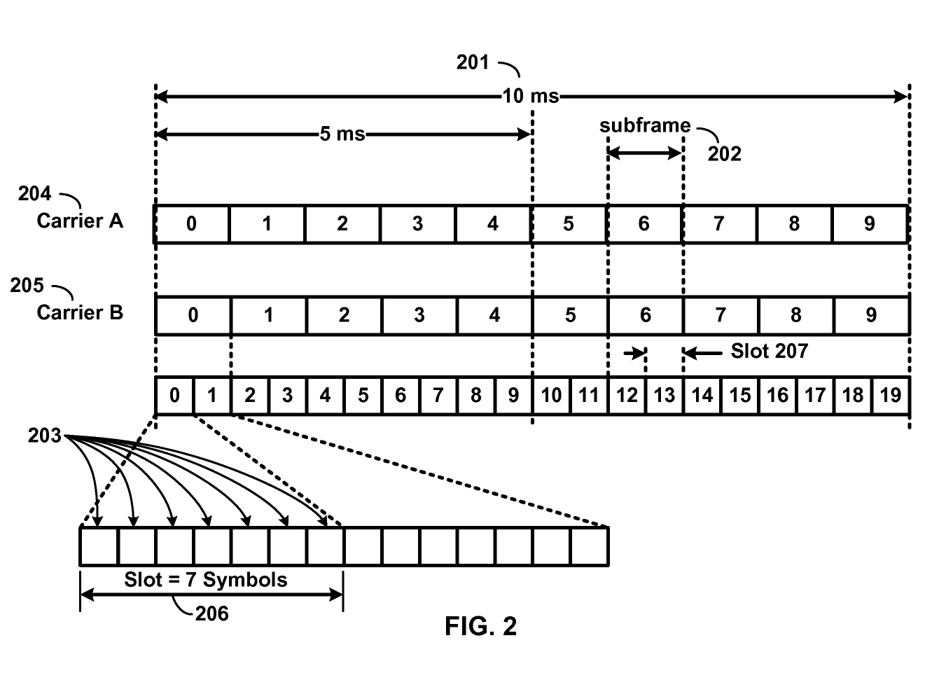

FIG. 2 is a diagram depicting an example transmission time and reception time for two carriers as per an aspect of an embodiment of the present invention. A multicarrier OFDM communication system may include one or more carriers, for example, ranging from 1 to 10 carriers. Carrier A 204 and carrier B 205 may have the same or different timing structures. Although FIG. 2 shows two synchronized carriers, carrier A 204 and carrier B 205 may or may not be synchronized with each other. Different radio frame structures may be supported for FDD (frequency division duplex) and TDD (time division duplex) duplex mechanisms. FIG. 2 shows an example FDD frame timing. Downlink and uplink transmissions may be organized into radio frames 201. In this example, radio frame duration is 10 msec. Other frame durations, for example, in the range of 1 to 100 msec may also be supported. In this example, each 10 ms radio frame 201 may be divided into ten equally sized sub-frames 202. Other subframe durations such as including 0.5 msec, 1 msec, 2 msec, and 5 msec may also be supported. Sub-frame(s) may consist of two or more slots 206. For the example of FDD, 10 subframes may be available for downlink transmission and 10 subframes may be available for uplink transmissions in each 10 ms interval. Uplink and downlink transmissions may be separated in the frequency domain. Slot(s) may include a plurality of OFDM symbols 203. The number of OFDM symbols 203 in a slot 206 may depend on the cyclic prefix length and subcarrier spacing.

In an example case of TDD, uplink and downlink transmissions may be separated in the time domain. According to some of the various aspects of embodiments, each 10 ms radio frame may include two half-frames of 5 ms each. Half-frame(s) may include eight slots of length 0.5 ms and three special fields: DwPTS (Downlink Pilot Time Slot), GP (Guard Period) and UpPTS (Uplink Pilot Time Slot). The length of DwPTS and UpPTS may be configurable subject to the total length of DwPTS, GP and UpPTS being equal to 1 ms. Both 5 ms and 10 ms switch-point periodicity may be supported. In an example, subframe 1 in all configurations and subframe 6 in configurations with 5 ms switch-point periodicity may include DwPTS, GP and UpPTS. Subframe 6 in configurations with 10 ms switch-point periodicity may include DwPTS. Other subframes may include two equally sized slots. For this TDD example, GP may be employed for downlink to uplink transition. Other subframes/fields may be assigned for either downlink or uplink transmission. Other frame structures in addition to the above two frame structures may also be supported, for example in one example embodiment the frame duration may be selected dynamically based on the packet sizes.

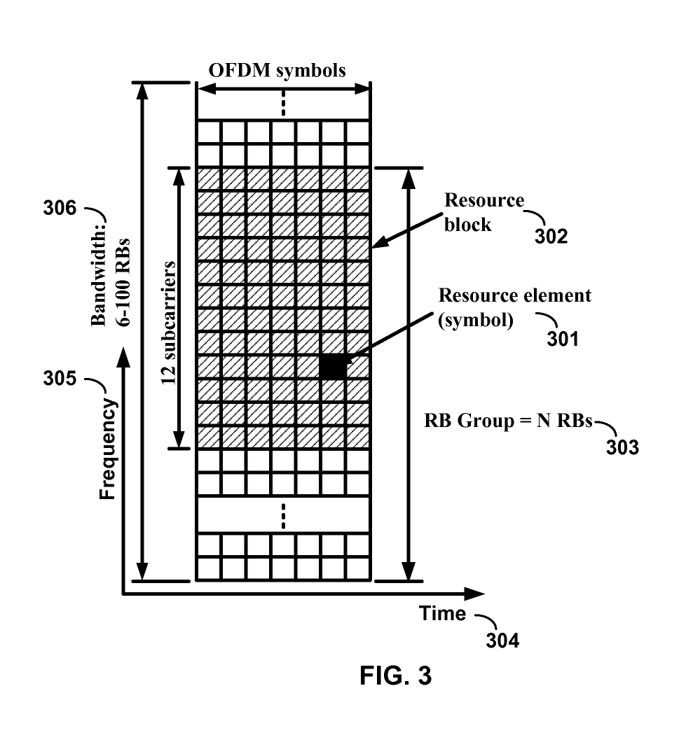

FIG. 3 is a diagram depicting OFDM radio resources as per an aspect of an embodiment of the present invention. The resource grid structure in time 304 and frequency 305 is illustrated in FIG. 3. The quantity of downlink subcarriers or resource blocks (RB) (in this example 6 to 100 RBs) may depend, at least in part, on the downlink transmission bandwidth 306 configured in the cell. The smallest radio resource unit may be called a resource element (e.g. 301). Resource elements may be grouped into resource blocks (e.g. 302). Resource blocks may be grouped into larger radio resources called Resource Block Groups (RBG) (e.g. 303). The transmitted signal in slot 206 may be described by one or several resource grids of a plurality of subcarriers and a plurality of OFDM symbols. Resource blocks may be used to describe the mapping of certain physical channels to resource elements. Other pre-defined groupings of physical resource elements may be implemented in the system depending on the radio technology. For example, 24 subcarriers may be grouped as a radio block for a duration of 5 msec.

Physical and virtual resource blocks may be defined. A physical resource block may be defined as N consecutive OFDM symbols in the time domain and M consecutive subcarriers in the frequency domain, wherein M and N are integers. A physical resource block may include M×N resource elements. In an illustrative example, a resource block may correspond to one slot in the time domain and 180 kHz in the frequency domain (for 15 KHz subcarrier bandwidth and 12 subcarriers). A virtual resource block may be of the same size as a physical resource block. Various types of virtual resource blocks may be defined (e.g. virtual resource blocks of localized type and virtual resource blocks of distributed type). For various types of virtual resource blocks, a pair of virtual resource blocks over two slots in a subframe may be assigned together by a single virtual resource block number. Virtual resource blocks of localized type may be mapped directly to physical resource blocks such that sequential virtual resource block k corresponds to physical resource block k. Alternatively, virtual resource blocks of distributed type may be mapped to physical resource blocks according to a predefined table or a predefined formula. Various configurations for radio resources may be supported under an OFDM framework, for example, a resource block may be defined as including the subcarriers in the entire band for an allocated time duration.

According to some of the various aspects of embodiments, an antenna port may be defined such that the channel over which a symbol on the antenna port is conveyed may be inferred from the channel over which another symbol on the same antenna port is conveyed. In some embodiments, there may be one resource grid per antenna port. The set of antenna port(s) supported may depend on the reference signal configuration in the cell. Cell-specific reference signals may support a configuration of one, two, or four antenna port(s) and may be transmitted on antenna port(s) {0}, {0, 1}, and {0, 1, 2, 3}, respectively. Multicast-broadcast reference signals may be transmitted on antenna port 4. Wireless device-specific reference signals may be transmitted on antenna port(s) 5, 7, 8, or one or several of ports {7, 8, 9, 10, 11, 12, 13, 14}. Positioning reference signals may be transmitted on antenna port 6. Channel state information (CSI) reference signals may support a configuration of one, two, four or eight antenna port(s) and may be transmitted on antenna port(s) 15, {15, 16}, {15, . . . , 18} and {15, . . . , 22}, respectively. Various configurations for antenna configuration may be supported depending on the number of antennas and the capability of the wireless devices and wireless base stations.

According to some embodiments, a radio resource framework using OFDM technology may be employed. Alternative embodiments may be implemented employing other radio technologies. Example transmission mechanisms include, but are not limited to: CDMA, OFDM, TDMA, Wavelet technologies, and/or the like. Hybrid transmission mechanisms such as TDMA/CDMA, and OFDM/CDMA may also be employed.

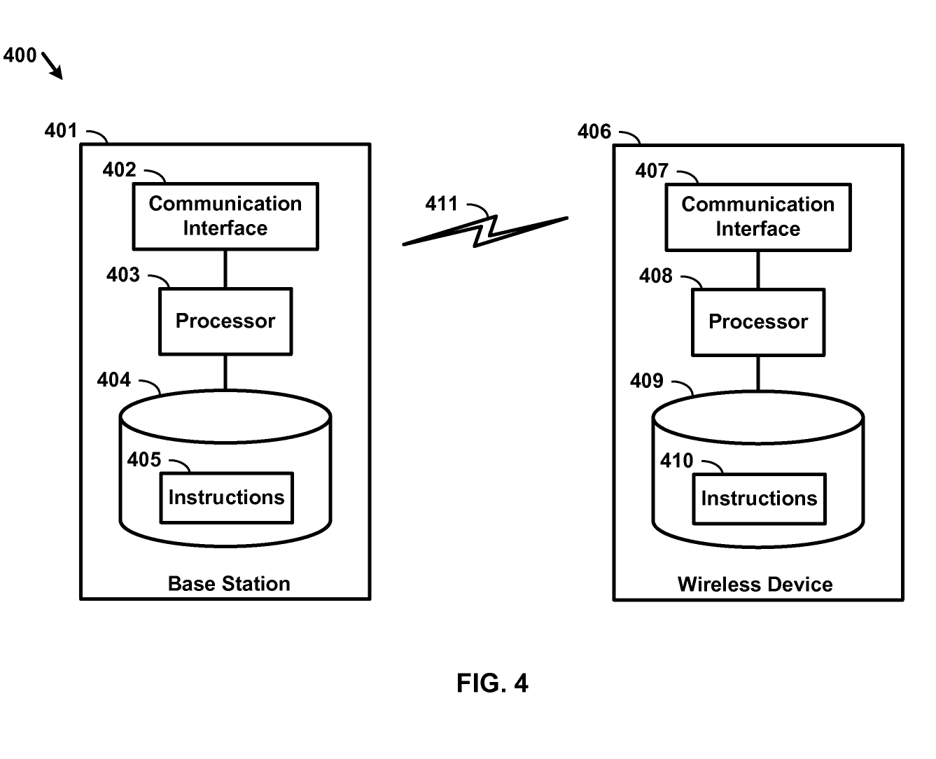

FIG. 4 is an example block diagram of a base station 401 and a wireless device 406, as per an aspect of an embodiment of the present invention. A communication network 400 may include at least one base station 401 and at least one wireless device 406. The base station 401 may include at least one communication interface 402, at least one processor 403, and at least one set of program code instructions 405 stored in non-transitory memory 404 and executable by the at least one processor 403. The wireless device 406 may include at least one communication interface 407, at least one processor 408, and at least one set of program code instructions 410 stored in non-transitory memory 409 and executable by the at least one processor 408. Communication interface 402 in base station 401 may be configured to engage in communication with communication interface 407 in wireless device 406 via a communication path that includes at least one wireless link 411. Wireless link 411 may be a bi-directional link. Communication interface 407 in wireless device 406 may also be configured to engage in a communication with communication interface 402 in base station 401. Base station 401 and wireless device 406 may be configured to send and receive data over wireless link 411 using multiple frequency carriers. According to some of the various aspects of embodiments, transceiver(s) may be employed. A transceiver is a device that includes both a transmitter and receiver. Transceivers may be employed in devices such as wireless devices, base stations, relay nodes, and/or the like. Example embodiments for radio technology implemented in communication interface 402, 407 and wireless link 411 are illustrated are FIG. 1, FIG. 2, and FIG. 3. and associated text.

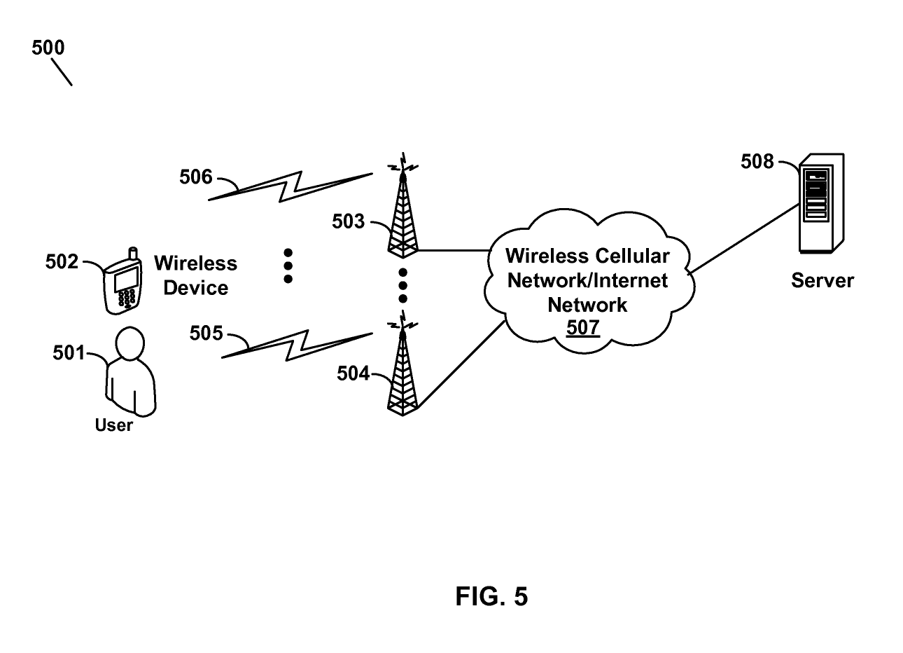

FIG. 5 is a block diagram depicting a system 500 for transmitting data traffic generated by a wireless device 502 to a server 508 over a multicarrier OFDM radio according to one aspect of the illustrative embodiments. The system 500 may include a Wireless Cellular Network/Internet Network 507, which may function to provide connectivity between one or more wireless devices 502 (e.g., a cell phone, PDA (personal digital assistant), other wirelessly-equipped device, and/or the like), one or more servers 508 (e.g. multimedia server, application servers, email servers, or database servers) and/or the like.

It should be understood, however, that this and other arrangements described herein are set forth for purposes of example only. As such, those skilled in the art will appreciate that other arrangements and other elements (e.g., machines, interfaces, functions, orders of functions, etc.) may be used instead, some elements may be added, and some elements may be omitted altogether. Further, as in most telecommunications applications, those skilled in the art will appreciate that many of the elements described herein are functional entities that may be implemented as discrete or distributed components or in conjunction with other components, and in any suitable combination and location. Still further, various functions described herein as being performed by one or more entities may be carried out by hardware, firmware and/or software logic in combination with hardware. For instance, various functions may be carried out by a processor executing a set of machine language instructions stored in memory.

As shown, the access network may include a plurality of base stations 503 . . . 504. Base station 503 . . . 504 of the access network may function to transmit and receive RF (radio frequency) radiation 505 . . . 506 at one or more carrier frequencies, and the RF radiation may provide one or more air interfaces over which the wireless device 502 may communicate with the base stations 503 . . . 504. The user 501 may use the wireless device (or UE: user equipment) to receive data traffic, such as one or more multimedia files, data files, pictures, video files, or voice mails, etc. The wireless device 502 may include applications such as web email, email applications, upload and ftp applications, MMS (multimedia messaging system) applications, or file sharing applications. In another example embodiment, the wireless device 502 may automatically send traffic to a server 508 without direct involvement of a user. For example, consider a wireless camera with automatic upload feature, or a video camera uploading videos to the remote server 508, or a personal computer equipped with an application transmitting traffic to a remote server.

One or more base stations 503 . . . 504 may define a corresponding wireless coverage area. The RF radiation 505 . . . 506 of the base stations 503 . . . 504 may carry communications between the Wireless Cellular Network/Internet Network 507 and access device 502 according to any of a variety of protocols. For example, RF radiation 505 . . . 506 may carry communications according to WiMAX (Worldwide Interoperability for Microwave Access e.g., IEEE 802.16), LTE (long term evolution), microwave, satellite, MMDS (Multichannel Multipoint Distribution Service), Wi-Fi (e.g., IEEE 802.11), Bluetooth, infrared, and other protocols now known or later developed. The communication between the wireless device 502 and the server 508 may be enabled by any networking and transport technology for example TCP/IP (transport control protocol/Internet protocol), RTP (real time protocol), RTCP (real time control protocol), HTTP (Hypertext Transfer Protocol) or any other networking protocol.

According to some of the various aspects of embodiments, an LTE network may include many base stations, providing a user plane (PDCP: packet data convergence protocol/RLC: radio link control/MAC: media access control/PHY: physical) and control plane (RRC: radio resource control) protocol terminations towards the wireless device. The base station(s) may be interconnected with other base station(s) by means of an X2 interface. The base stations may also be connected by means of an S1 interface to an EPC (Evolved Packet Core). For example, the base stations may be interconnected to the MME (Mobility Management Entity) by means of the S1-MME interface and to the Serving Gateway (S-GW) by means of the S1-U interface. The S1 interface may support a many-to-many relation between MMEs/Serving Gateways and base stations. A base station may include many sectors for example: 1, 2, 3, 4, or 6 sectors. A base station may include many cells, for example, ranging from 1 to 50 cells or more. A cell may be categorized, for example, as a primary cell or secondary cell. When carrier aggregation is configured, a wireless device may have one RRC connection with the network. At RRC connection establishment/re-establishment/handover, one serving cell may provide the NAS (non-access stratum) mobility information (e.g. TAI-tracking area identifier), and at RRC connection re-establishment/handover, one serving cell may provide the security input. This cell may be referred to as the Primary Cell (PCell). In the downlink, the carrier corresponding to the PCell may be the Downlink Primary Component Carrier (DL PCC), while in the uplink, it may be the Uplink Primary Component Carrier (UL PCC). Depending on wireless device capabilities, Secondary Cells (SCells) may be configured to form together with the PCell a set of serving cells. In the downlink, the carrier corresponding to an SCell may be a Downlink Secondary Component Carrier (DL SCC), while in the uplink, it may be an Uplink Secondary Component Carrier (UL SCC). An SCell may or may not have an uplink carrier.

A cell, comprising a downlink carrier and optionally an uplink carrier, is assigned a physical cell ID and a cell index. A carrier (downlink or uplink) belongs to only one cell, the cell ID or Cell index may also identify the downlink carrier or uplink carrier of the cell (depending on the context it is used). In the specification, cell ID may be equally referred to a carrier ID, and cell index may be referred to carrier index. In implementation, the physical cell ID or cell index may be assigned to a cell. Cell ID may be determined using the synchronization signal transmitted on a downlink carrier. Cell index may be determined using RRC messages. For example, when the specification refers to a first physical cell ID for a first downlink carrier, it may mean the first physical cell ID is for a cell comprising the first downlink carrier. The same concept may apply to, for example, carrier activation. When the specification indicates that a first carrier is activated, it equally means that the cell comprising the first carrier is activated.

Embodiments may be configured to operate as needed. The disclosed mechanism may be performed when certain criteria are met, for example, in wireless device, base station, radio environment, network, a combination of the above, and/or the like. Example criteria may be based, at least in part, on for example, traffic load, initial system set up, packet sizes, traffic characteristics, a combination of the above, and/or the like. When the one or more criteria are met, the example embodiments may be applied. Therefore, it may be possible to implement example embodiments that selectively implement disclosed protocols.

Example embodiments of the invention may employ RRC messages for carrier activation in an OFDM communication system. Other example embodiments may comprise a non-transitory tangible computer readable media comprising instructions executable by one or more processors to cause RRC messages to activate a carrier in an OFDM communication system. Yet other example embodiments may comprise an article of manufacture that comprises a non-transitory tangible computer readable machine-accessible medium having instructions encoded thereon for enabling programmable hardware to cause a device (e.g. wireless communicator, UE, base station, etc.) to employ RRC messages for carrier activation in an OFDM communication system. The device may include processors, memory, interfaces, and/or the like. Other example embodiments may comprise communication networks comprising devices such as base stations, wireless devices (UE), servers, switches, antennas, and/or the like.

To enable reasonable wireless device battery consumption when carrier aggregation (CA) of multiple carriers is configured, an activation/deactivation mechanism of secondary carriers may be supported. Activation/deactivation may not apply to the primary carrier. When a secondary carrier is deactivated, the wireless device may not receive the corresponding physical downlink control channel (PDCCH) or physical downlink shared channel (PDSCH), and may not transmit in the corresponding uplink. A deactivated carrier may not be required to perform channel quality indicator (CQI) measurements. When a secondary carrier is active, the wireless device may receive PDSCH and PDCCH if the wireless device is configured to monitor PDCCH from this secondary carrier.

As defined in 3GPP 36.300 release 10.4.0, the activation/deactivation mechanism is only based on the combination of a MAC control element and deactivation timers. The MAC control element carries a bitmap for the activation and deactivation of secondary cells: a bit set to 1 denotes activation of the corresponding secondary cell, while a bit set to 0 denotes deactivation. With the bitmap, secondary cells may be activated and deactivated individually, and a single activation/deactivation command may activate/deactivate a subset of the secondary cells. One deactivation timer is maintained per secondary cell but one common value is configured per wireless device by RRC. At reconfiguration without mobility control information: secondary cells added to the set of serving cells are always initially “deactivated”, and secondary cells which remain in the set of serving cells (either unchanged or reconfigured) do not change their activation status (“activated” or “deactivated”). At reconfiguration with mobility control information (i.e. handover), secondary cells are always “deactivated”.

This process defined in 3GPP 36.300 standard may be inefficient in many scenarios. In an implementation, the wireless device may not activate a receiver immediately after it receives an activation command. The activation process in the wireless device may require a time delay which depends on the wireless device's hardware and software configuration. In an example implementation, the activation time duration may range from 4 to 8 msec. During this time, the base station may not transmit any data packets to the wireless device using the newly added secondary cell. In the existing standard, transmitting traffic on a new cell may be performed in two steps: configuring the newly added cell using RRC protocols, and then activating the cell using MAC protocol activation command. This two step protocol process increases the delay in transmission of data on the newly added second cell.

Example embodiments may resolve this inefficiency by introducing a novel mechanism for adding and configuring new secondary cells. A cell may be configured and activated using the RRC protocol. Example embodiments may reduce the delay for sending data traffic on a new secondary cell. Example embodiments may also reduce the data traffic transfer delay during a handover process in which multiple cells may be configured in the wireless device for target base station data traffic transmission. The source base station may activate the required secondary cells using an RRC reconfiguration message. Example embodiments may address issues in existing mechanisms currently used for cell activation.

Example embodiments are different from current soft handover methods implemented in various technologies. In soft handover, multiple cells have the same frequency and may transmit the same data traffic to the wireless device. In example embodiments, different cells may carry different streams of data traffic to increase the transmission bit rate. In a scenario, in which a new cell is added to an existing base station, different cells may have different cell frequencies. In example handover embodiments, a new cell from a target base station may be added to increase the transmission bit rate of the target base station.

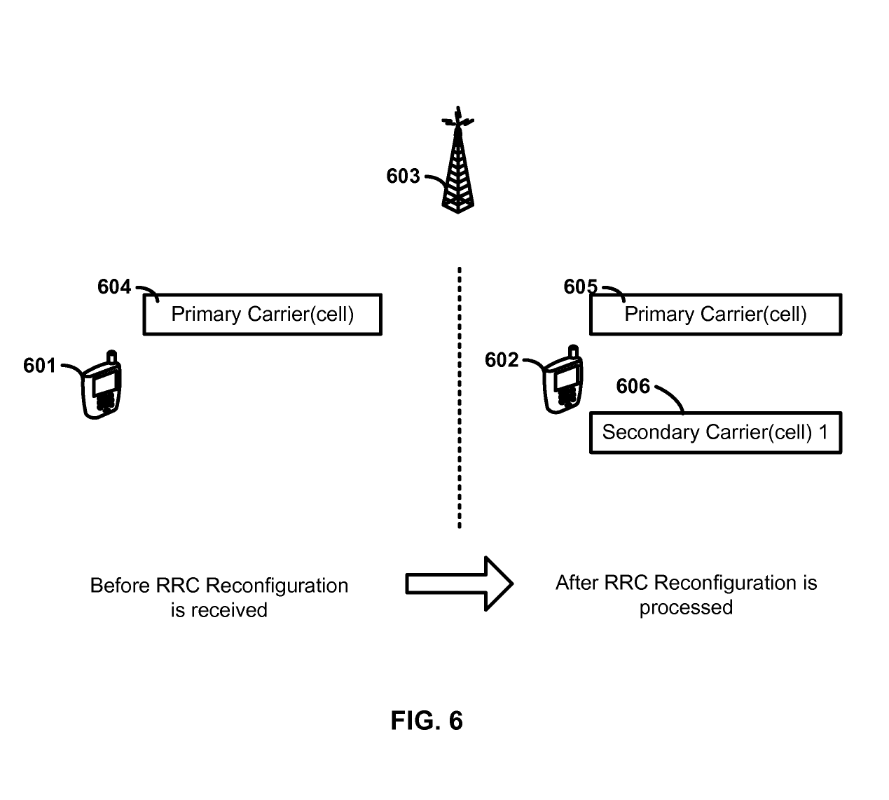

FIG. 6 is an example diagram depicting changes in carrier configuration as per an aspect of an embodiment of the present invention. Example embodiments provide a method and system for a base station 603 in a communication network. The base station may be configured to communicate employing a plurality of carriers. Each of the plurality of carriers may comprise a plurality of OFDM subcarriers. Transmission time may be divided into a plurality of subframes, and each subframe in the plurality of subframes may further be divided into a plurality of OFDM symbols.

A memory may be configured to store, for at least one RRC-connected wireless device 601: an identity of a primary carrier 604 in the plurality of carriers and an identity of each of at least one secondary carrier 606 in the plurality of carriers. Wireless device 602 is wireless device 601 reconfigured. Primary carrier 605 may be primary carrier 604 reconfigured to operate with reconfigured wireless device 602. An identity of a carrier may be the identity of a cell comprising the carrier. Cells and carriers may be used interchangeably in this specification. The base station may maintain an activation status of each of said at least one secondary carrier for each RRC-connected wireless device. The base station may transmit an RRC reconfiguration message to an RRC-connected wireless device in the at least one RRC-connected wireless device using a first plurality of OFDM subcarriers in the plurality of OFDM subcarriers. The RRC reconfiguration message may configure at least one new secondary carrier 606 in the at least one secondary carrier for the RRC-connected wireless device. The RRC reconfiguration message may include: the identity of each of the at least one new secondary carrier 606, configuration information about the at least one new secondary carrier, and/or the activation status field of the at least one new secondary carrier.

The activation status field may comprise an active or inactive status for each of the at least one new secondary carrier. The activation status may be configured to cause the RRC-connected wireless device to control the activation of each of the at least one new secondary carrier according to said activation status field. Carrier activation may imply cell activation, and carrier ID may be referred to as cell ID. Each carrier may belong to only one cell. The activation status could determine the activation or deactivation status of a transceiver module in the RRC-connected wireless device for the at least one new secondary carrier after the RRC reconfiguration message is successfully processed by the RRC-connected wireless device. In another example scenario, the RRC reconfiguration message may not comprise the activation status field of the at least one new secondary carrier, and the status of the at least one new secondary carrier may be considered active by default when carrier(s) are added.

The base station 603 may receive an RRC reconfiguration complete message from the RRC-connected wireless device 602 indicating that the RRC reconfiguration message is received by wireless device 602. The base station 603 may transmit a plurality of data packets to the RRC-connected wireless device on a data channel on at least one of the at least one new secondary carrier 606 using a second plurality of OFDM subcarriers in the plurality of OFDM subcarriers.

According to some of the various aspects of embodiments, when a packet in the plurality of data packets is transmitted on an active carrier in the at least one secondary carrier, the deactivation timer associated to the active carrier may be restarted. There may be at least a guard band between each two carriers in the plurality of carriers. The primary carrier may not be deactivated when the wireless device is in an RRC-connected state. The at least one new secondary carrier may be deactivated if the associated deactivation timer expires after a last packet buffered for transmission to the wireless device is transmitted over the at least one new secondary carrier.

When the at least one new secondary carrier is deactivated, the wireless device may not process the corresponding PDCCH or PDSCH. When the at least one new secondary carrier is deactivated, the wireless device may not transmit in the corresponding uplink. After the at least one new secondary carrier is deactivated, the wireless device may not be required to perform CQI measurements for the at least one new secondary carrier.

The at least one new secondary carrier may be a carrier employed for signal transmission by the base station. When a carrier transceiver is activated, the transceiver may be configured to process the signal received from the at least one new secondary carrier. An OFDM receiver may process the signals received from multiple carriers simultaneously using a single FFT processor. An active carrier transceiver module that processes the OFDM carrier signal may consume wireless device battery power, and therefore may be activated when it is needed for additional bit rate. The RRC reconfiguration complete message may further indicate that the RRC reconfiguration message is successfully processed by the RRC-connected wireless device.

According to some of the various aspects of embodiments, the RRC reconfiguration message and RRC reconfiguration complete message may be encrypted and protected by an integrity header before being transmitted. The RRC reconfiguration message may set up or modify at least one radio bearer. The RRC reconfiguration message may modify configuration of at least one parameter of a MAC layer or a physical layer.

A scheduling control packet may be transmitted before each packet in the plurality of data packets is transmitted. The scheduling control packet may comprise information about the subcarriers used for packet transmission. Transmission time is divided into a plurality of subframes, and subframe timing of the at least one secondary carrier may be synchronized with subframe timing of the primary carrier. The RRC reconfiguration message may be an RRC Connection Reconfiguration message in LTE-advanced technology. The RRC reconfiguration message could modify an RRC connection. The RRC reconfiguration message may comprise measurement configuration and/or an RRC transaction identifier. The RRC reconfiguration complete message may comprise an RRC transaction identifier.

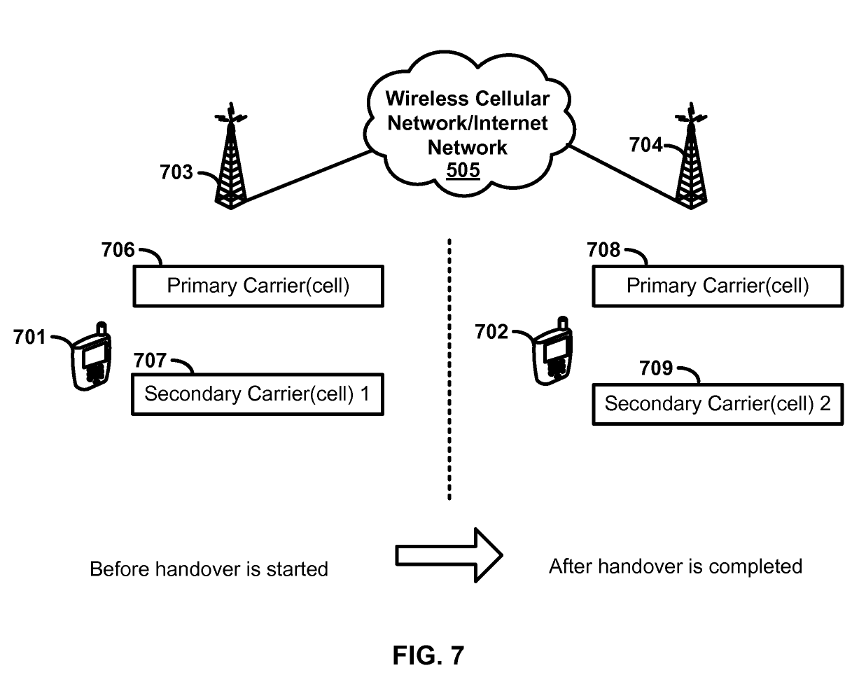

FIG. 7 is an example high level diagram depicting changes in carrier configuration during handover according to aspect(s) of the illustrative embodiments. Another example embodiment may provide a method and system for handover from a source base station 703 to a target base station 704 in a communication network comprising a plurality of carriers. Each of the plurality of carriers comprises a plurality of OFDM subcarriers. The handover may be between a serving cell belonging to the serving base station 703 and a target cell belonging to a target base station 704. In an example, serving cell and target cell may belong to two sectors of the same base station. When the specification indicates a handover between a serving base station 703 and a target base station 704, it implies that the handover is between a serving cell to a target cell. In an example, serving base station 703 and target base station 704 may be the same base station. The source base station 703 may be connected to the target base station 704 using a wireless cellular network or an Internet network 705. In other example deployment scenarios, the source base station 703 and target base stations 704 may be connected via any networking technology such as IP, MPLS, Ethernet, microwave, WiFi, LTE, WiMAX, satellite communications or a combination of these technologies or other newly implemented technologies.

The source base station 703 may transmit an RRC reconfiguration message to an RRC-connected wireless device 701 using a first plurality of OFDM subcarriers in the plurality of OFDM subcarriers. The RRC-connected wireless device may be connected to the source base station 703 using carriers 706 and 707. The RRC reconfiguration message may configure at least one new secondary carrier 709 in the plurality of carriers for the RRC-connected wireless device 701. The at least one new secondary carrier is a carrier transmitted by the target base station 704. During the handover process, the at least one new secondary carrier 709 may have the same frequency as the frequency of a carrier in the serving base station 707. For example secondary carrier one 707 may have the same frequency as secondary carrier 709. In another example, the at least one new secondary carrier 709 may have a different frequency as the frequency of a carrier 707 in the serving base station 703. A carrier could be called a new carrier, for example when it is transmitted at a different frequency or when it is transmitted by a different base station from the serving base station 703.

According to some of the various aspects of embodiments, the RRC reconfiguration message may comprise an identity of each of the at least one new secondary carrier 709, configuration information about the at least one new secondary carrier 709, activation status field for the at least one new secondary carrier, and/or mobility control information. The RRC reconfiguration message may also comprise the configuration information about the primary carrier 708. The activation status could determine the activation or deactivation status of a module in the RRC-connected wireless device 702 for the at least one new secondary carrier 709 after the RRC reconfiguration message is successfully processed by the RRC-connected wireless device 702. In another example scenario, the RRC reconfiguration message may not comprise the activation status of the at least one new secondary carrier 709, and status of the at least one new secondary carrier 709 may be considered active by default when they are added.

The target base station 704 may receive an RRC reconfiguration complete message from the RRC-connected wireless device 702 indicating that the RRC reconfiguration message is received by the wireless device. The target base station 704 may transmit a plurality of data packets to the RRC-connected wireless device 702 on a data channel on at least one of the at least one new secondary carrier using a second plurality of OFDM subcarriers in the plurality of OFDM subcarriers. The target base station may maintain a deactivation timer for each active module in the RRC-connected wireless device 702 and may deactivate an active carrier in the at least one new secondary carrier after the associated deactivation timer expires. The at least one new secondary carrier is a carrier that is employed for signal transmission by the target base station 704. When a packet in the plurality of data packets is transmitted on an active carrier in the at least one new secondary carrier, the deactivation timer associated to the active carrier may be restarted.

When a packet in the plurality of data packets is transmitted on an active carrier in the at least one secondary carrier, the deactivation timer associated to the active carrier may be restarted. The at least one new secondary carrier may be deactivated if the associated deactivation timer expires after a last packet in the plurality of data packets is transmitted over the at least one new secondary carrier.

When the at least one new secondary carrier is deactivated, the wireless device may not process the corresponding PDCCH or PDSCH. When the at least one new secondary carrier is deactivated, the wireless device may not transmit in the corresponding uplink. After the at least one new secondary carrier is deactivated, the wireless device may not be required to perform CQI measurements for the at least one new secondary carrier.

The at least one new secondary carrier is a carrier transmitted by the target base station. When the carrier transceiver module is activated, the carrier transceiver module may be configured to processes the signal received from the at least one new secondary carrier. The RRC reconfiguration complete message may further indicate that the RRC reconfiguration message is successfully processed by the RRC-connected wireless device. The RRC reconfiguration message and RRC reconfiguration complete message may be encrypted and protected by an integrity header before being transmitted.

A scheduling control packet may be transmitted before each packet in the plurality of data packets is transmitted. The scheduling control packet may comprise information about the subcarriers used for packet transmission. Transmission time is divided into a plurality of subframes. The RRC reconfiguration message could be an RRC Connection Reconfiguration message in LTE-advanced technology. The RRC reconfiguration message may comprise measurement configuration and/or an RRC transaction identifier. The RRC reconfiguration complete message may comprise an RRC transaction identifier.

Another example embodiment provides a method and system for a wireless device 601, 602, 701, 702 in a communication network. The wireless device may be configured to communicate employing a plurality of carriers. Each of the plurality of carriers may comprise a plurality of OFDM subcarriers. Reception time may be divided into a plurality of subframes, and each subframe in the plurality of subframes may further be divided into a plurality of OFDM symbols.

The wireless device may receive an RRC reconfiguration message on a first plurality of OFDM subcarriers in the plurality of OFDM subcarriers from a base station 603 or 703. The RRC reconfiguration message may configure at least one new secondary carrier 606 or 709 in the plurality of carriers. The RRC reconfiguration message may include: an identity of each of the at least one new secondary carrier, configuration information about the at least one new secondary carrier, and an activation status field for the at least one new secondary carrier. The activation status field may have an active or inactive status for each of the at least one new secondary carrier. The activation status field may be configured to cause the RRC-connected wireless device to control the activation or deactivation status of a carrier transceiver module in the wireless device for the at least one new secondary carrier after the RRC reconfiguration message is successfully processed by the wireless device. In another example scenario, the RRC reconfiguration message may not comprise the activation status field of the at least one new secondary carrier, and the status of the at least one new secondary carrier may be considered active by default when they are configured.

The wireless device may transmit an RRC reconfiguration complete message indicating that the RRC reconfiguration message is received by the wireless device. The wireless device may receive a plurality of data packets on a data channel on at least one of the at least one new secondary carrier on a second plurality of OFDM subcarriers in the plurality of OFDM subcarriers.

The wireless device may receive an RRC reconfiguration message on a first plurality of OFDM subcarriers in the plurality of OFDM subcarriers from a base station 603 or 703. The RRC reconfiguration message may configure at least one new secondary carrier in the plurality of carriers. The RRC reconfiguration message may include: an identity of each of the at least one new secondary carrier, configuration information about the at least one new secondary carrier, and activation status field of the at least one new secondary carrier. In another example scenario, the RRC reconfiguration message may not comprise the activation status of the at least one new secondary carrier, and status of the at least one new secondary carrier may be considered active by default when they are added.

The activation status field may be configured to cause the RRC-connected wireless device to control activation or deactivation status of a carrier transceiver module in the wireless device for the at least one new secondary carrier after the RRC reconfiguration message is successfully processed by the wireless device. The memory may store and maintain a deactivation timer for each active carrier in the at least one new secondary carrier. The wireless device may transmit an RRC reconfiguration complete message indicating that the RRC reconfiguration message is received by the wireless device. The wireless device may receive a plurality of data packets on a data channel on at least one of the at least one new secondary carrier on a second plurality of OFDM subcarriers in the plurality of OFDM subcarriers. The wireless device may be configured to deactivate an active carrier in the at least one new secondary carrier after the associated deactivation timer expires.

When a packet in the plurality of data packets is received on an active carrier in the at least one new secondary carrier, the deactivation timer associated to the active carrier may be restarted. The primary carrier may not be deactivated when the wireless device is in RRC-connected state. The at least one new secondary carrier may be deactivated if the associated deactivation timer expires after a last packet in the plurality of data packets is received over the at least one new secondary carrier. When the at least one new secondary carrier is deactivated, the wireless device may not process the corresponding PDCCH or PDSCH. When the at least one new secondary carrier is deactivated, the wireless device may not transmit in the corresponding uplink. When the at least one new secondary carrier is deactivated, the wireless device may not be required to perform CQI measurements for the at least one new secondary carrier.

According to some of the various aspects of embodiments, the RRC reconfiguration message may comprise mobility control information. The at least one new secondary carrier may be a carrier employed for signal transmission by a serving base station. During the handover process, the at least one new secondary carrier may be a carrier transmitted by a target base station. When the carrier transceiver module is activated, the module may be configured to processes the signal received from the at least one new secondary carrier.

The RRC reconfiguration complete message may further indicate that the RRC reconfiguration message is successfully processed by the wireless device. The RRC reconfiguration message and RRC reconfiguration complete message may be encrypted and protected by an integrity header before being transmitted. The RRC reconfiguration message may set up or modify at least one radio bearer. The RRC reconfiguration message may modify configuration of at least one parameter of a MAC layer or a physical layer.

The RRC reconfiguration message may be an RRC Connection Reconfiguration message in LTE-advanced technology. The RRC reconfiguration message may modify an RRC connection.

The RRC reconfiguration message may comprise measurement configuration. The RRC reconfiguration message may comprise an RRC transaction identifier. The RRC reconfiguration complete message may comprise an RRC transaction identifier. A scheduling control packet may be received before each packet in the plurality of data packets is received. The scheduling control packet may comprise information about the subcarriers used for packet reception.

The transmission and reception mechanism introduced in the example embodiments may enable the transmitter to activate the second carrier faster and use the second carrier for packet transmission to reduce carrier activation delay and increase the bit rate in the system. Carriers could be activated when they are configured by the RRC layer instead of being activated at a later time using a MAC activation command. The second carrier may be used to provide additional throughput. In an example embodiment implemented in an LTE network, the scheduling control packet may be transmitted in a physical downlink control channel (PDCCH).

According to some of the various aspects of embodiments, in carrier aggregation (CA), two or more carriers could be aggregated in order to support wider transmission bandwidths. A wireless device may simultaneously receive or transmit on one or multiple carriers depending on its capabilities. An LTE Rel-10 or beyond terminal with reception and/or transmission capabilities for CA could simultaneously receive and/or transmit on multiple carriers corresponding to multiple serving cells belonging to the same or different transmitters. An LTE Rel-8/9 wireless device could receive on a single carrier and transmit on a single carrier corresponding to one serving cell only.

CA may be supported for both contiguous and non-contiguous carriers with each carrier being limited to a maximum of 110 Resource Blocks in the frequency domain using the Rel-8/9 numerology. It may be possible to configure a wireless device to aggregate a different number of carriers originating from the same base station and of possibly different bandwidths in the uplink and the downlink. The number of downlink carriers that could be configured depends on the downlink aggregation capability of the terminal. The number of uplink carriers that may be configured depends on the uplink aggregation capability of the terminal. It may not be possible to configure a wireless device with more uplink carriers than downlink carriers. In typical TDD deployments, the number of carriers and the bandwidth of each carrier in uplink and downlink may be the same. Carriers originating from the same base station may not provide the same coverage.

Carriers may be LTE Rel-8/9 compatible, in some implementation some of the carriers may not be LTE Rel-8/9 compatible. The spacing between center frequencies of contiguously aggregated carriers may be a multiple of 300 kHz. This may be in order to be compatible with the 100 kHz frequency raster of Rel-8/9 and at the same time preserve orthogonality of the subcarriers with 15 kHz spacing. Depending on the aggregation scenario, the n×300 kHz spacing could be facilitated by insertion of a low number of unused subcarriers between contiguous CCs.

Depending on wireless device capabilities, secondary cells could be configured to form together with the primary cell a set of serving cells. In the downlink, the carrier corresponding to a secondary cell is a downlink secondary carrier while in the uplink it is an uplink secondary carrier. The configured set of serving cells for a wireless device therefore may comprise of one primary cell and one or more secondary cells. For each secondary cell the usage of uplink resources by the wireless device in addition to the downlink ones could be configurable. The number of downlink secondary carriers configured is therefore always larger than or equal to the number of uplink secondary carriers and no secondary cell may be configured for usage of uplink resources only. A cell comprises a downlink carrier and optionally a corresponding uplink carrier. A carrier may belong to only one cell. Carrier and cell may be used interchangeably in this specification.

From a wireless device viewpoint, each uplink resource may belong to one serving cell. The number of serving cells that could be configured depends on the aggregation capability of the wireless device. Primary cell could be changed with handover procedure (i.e. with security key change and RACH procedure). A primary cell may be used for transmission of PUCCH. Unlike secondary cells, a primary cell may not be de-activated. Re-establishment may be triggered when a primary cell experiences radio link failure, and not when secondary cells experience radio link failure. NAS information may be taken from a primary cell.

The reconfiguration, addition and removal of secondary cells could be performed by RRC. At intra-LTE handover, RRC may also add, remove, or reconfigure secondary cells for usage with the target primary cell. When adding a new secondary cell, dedicated RRC signaling may be used for sending required system information of the secondary cell, i.e. while in connected mode, wireless devices may not acquire broadcasted system information directly from the secondary cells.

In the example embodiments, RRC control messages or control packets may be scheduled for transmission in the physical downlink shared channel (PDSCH). PDSCH may carry control and data messages/packets. Control messages or packets may be processed before transmission, for example, they may be fragmented or multiplexed before transmission. A control message in the upper layer may be processed as a data packet in the MAC or physical layer. For example, system information blocks as well as data traffic may be scheduled for transmission in PDSCH. The data packets may be encrypted packets. Data packets may be encrypted before transmission to secure the packets from unwanted receivers. The desired recipient may be able to decrypt the packets. The data packets could be encrypted using an encryption key and at least one parameter that changes substantially rapidly over time, for example, employing a system counter that changes every frame, subframe, or every k subframe or frame. k, may be, for example, in the range of 1 to 50. This encryption mechanism that may provide a transmission that may not be easily eavesdropped by unwanted receivers. An example embodiment may comprise additional parameters in an encryption module that changes substantially rapidly in time and may enhance the security mechanism. An example varying parameter could be any types of system counter. The encryption may be provided by the PDCP layer between the transmitter and receiver. Additional overhead added to the packets by the lower layers such as RLC, MAC, and Physical layer may not be encrypted before transmission.

According to some of the various aspects of embodiments, the packets in the downlink may be transmitted via downlink physical channels. The carrying packets in the uplink may be transmitted via uplink physical channels. The baseband data representing a downlink physical channel may be defined in terms of at least one of the following actions: scrambling of coded bits in codewords to be transmitted on a physical channel; modulation of scrambled bits to generate complex-valued modulation symbols; mapping of the complex-valued modulation symbols onto one or several transmission layers; precoding of the complex-valued modulation symbols on layer(s) for transmission on the antenna port(s); mapping of complex-valued modulation symbols for antenna port(s) to resource elements; and/or generation of complex-valued time-domain OFDM signal(s) for antenna port(s).

Codeword, transmitted on the physical channel in one subframe, may be scrambled prior to modulation, resulting in a block of scrambled bits. The scrambling sequence generator may be initialized at the start of subframe(s). Codeword(s) may be modulated using QPSK, 16QAM, 64QAM, 128QAM, and/or the like resulting in a block of complex-valued modulation symbols. The complex-valued modulation symbols for codewords to be transmitted may be mapped onto one or several layers. For transmission on a single antenna port, a single layer may be used. For spatial multiplexing, the number of layers may be less than or equal to the number of antenna port(s) used for transmission of the physical channel. The case of a single codeword mapped to multiple layers may be applicable when the number of cell-specific reference signals is four or when the number of UE-specific reference signals is two or larger. For transmit diversity, there may be one codeword and the number of layers may be equal to the number of antenna port(s) used for transmission of the physical channel.

The precoder may receive a block of vectors from the layer mapping and generate a block of vectors to be mapped onto resources on the antenna port(s). Precoding for spatial multiplexing using antenna port(s) with cell-specific reference signals may be used in combination with layer mapping for spatial multiplexing. Spatial multiplexing may support two or four antenna ports and the set of antenna ports used may be {0,1} or {0, 1, 2, 3}. Precoding for transmit diversity may be used in combination with layer mapping for transmit diversity. The precoding operation for transmit diversity may be defined for two and four antenna ports. Precoding for spatial multiplexing using antenna ports with UE-specific reference signals may also, for example, be used in combination with layer mapping for spatial multiplexing. Spatial multiplexing using antenna ports with UE-specific reference signals may support up to eight antenna ports. Reference signals may be pre-defined signals that may be used by the receiver for decoding the received physical signal, estimating the channel state, and/or other purposes.

For antenna port(s) used for transmission of the physical channel, the block of complex-valued symbols may be mapped in sequence to resource elements. In resource blocks in which UE-specific reference signals are not transmitted the PDSCH may be transmitted on the same set of antenna ports as the physical broadcast channel in the downlink (PBCH). In resource blocks in which UE-specific reference signals are transmitted, the PDSCH may be transmitted, for example, on antenna port(s) {5, {7}, {8}, or {7, 8, . . . , v+6}, where v is the number of layers used for transmission of the PDSCH.

Common reference signal(s) may be transmitted in physical antenna port(s). Common reference signal(s) may be cell-specific reference signal(s) (RS) used for demodulation and/or measurement purposes. Channel estimation accuracy using common reference signal(s) may be reasonable for demodulation (high RS density). Common reference signal(s) may be defined for LTE technologies, LTE-advanced technologies, and/or the like. Demodulation reference signal(s) may be transmitted in virtual antenna port(s) (i.e., layer or stream). Channel estimation accuracy using demodulation reference signal(s) may be reasonable within allocated time/frequency resources. Demodulation reference signal(s) may be defined for LTE-advanced technology and may not be applicable to LTE technology. Measurement reference signal(s), may also called CSI (channel state information) reference signal(s), may be transmitted in physical antenna port(s) or virtualized antenna port(s). Measurement reference signal(s) may be Cell-specific RS used for measurement purposes. Channel estimation accuracy may be relatively lower than demodulation RS. CSI reference signal(s) may be defined for LTE-advanced technology and may not be applicable to LTE technology.

In at least one of the various embodiments, uplink physical channel(s) may correspond to a set of resource elements carrying information originating from higher layers. The following example uplink physical channel(s) may be defined for uplink: a) Physical Uplink Shared Channel (PUSCH), b) Physical Uplink Control Channel (PUCCH), c) Physical Random Access Channel (PRACH), and/or the like. Uplink physical signal(s) may be used by the physical layer and may not carry information originating from higher layers. For example, reference signal(s) may be considered as uplink physical signal(s). Transmitted signal(s) in slot(s) may be described by one or several resource grids including, for example, subcarriers and SC-FDMA or OFDMA symbols. Antenna port(s) may be defined such that the channel over which symbol(s) on antenna port(s) may be conveyed and/or inferred from the channel over which other symbol(s) on the same antenna port(s) is/are conveyed. There may be one resource grid per antenna port. The antenna port(s) used for transmission of physical channel(s) or signal(s) may depend on the number of antenna port(s) configured for the physical channel(s) or signal(s).

Element(s) in a resource grid may be called a resource element. A physical resource block may be defined as N consecutive SC-FDMA symbols in the time domain and/or M consecutive subcarriers in the frequency domain, wherein M and N may be pre-defined integer values. Physical resource block(s) in uplink(s) may comprise of M×N resource elements. For example, a physical resource block may correspond to one slot in the time domain and 180 kHz in the frequency domain. Baseband signal(s) representing the physical uplink shared channel may be defined in terms of: a) scrambling, b) modulation of scrambled bits to generate complex-valued symbols, c) mapping of complex-valued modulation symbols onto one or several transmission layers, d) transform precoding to generate complex-valued symbols, e) precoding of complex-valued symbols, f) mapping of precoded complex-valued symbols to resource elements, g) generation of complex-valued time-domain SC-FDMA signal(s) for antenna port(s), and/or the like.

For codeword(s), block(s) of bits may be scrambled with UE-specific scrambling sequence(s) prior to modulation, resulting in block(s) of scrambled bits. Complex-valued modulation symbols for codeword(s) to be transmitted may be mapped onto one, two, or more layers. For spatial multiplexing, layer mapping(s) may be performed according to pre-defined formula (s). The number of layers may be less than or equal to the number of antenna port(s) used for transmission of physical uplink shared channel(s). The example of a single codeword mapped to multiple layers may be applicable when the number of antenna port(s) used for PUSCH is, for example, four. For layer(s), the block of complex-valued symbols may be divided into multiple sets, each corresponding to one SC-FDMA symbol. Transform precoding may be applied. For antenna port(s) used for transmission of the PUSCH in a subframe, block(s) of complex-valued symbols may be multiplied with an amplitude scaling factor in order to conform to a required transmit power, and mapped in sequence to physical resource block(s) on antenna port(s) and assigned for transmission of PUSCH.

According to some of the various embodiments, data may arrive to the coding unit in the form of two transport blocks every transmission time interval (TTI) per UL cell. The following coding actions may be identified for transport block(s) of an uplink carrier: a) Add CRC to the transport block, b) Code block segmentation and code block CRC attachment, c) Channel coding of data and control information, d) Rate matching, e) Code block concatenation. f) Multiplexing of data and control information, g) Channel interleaver, h) Error detection may be provided on UL-SCH (uplink shared channel) transport block(s) through a Cyclic Redundancy Check (CRC), and/or the like. Transport block(s) may be used to calculate CRC parity bits. Code block(s) may be delivered to channel coding block(s). Code block(s) may be individually turbo encoded. Turbo coded block(s) may be delivered to rate matching block(s).

Physical uplink control channel(s) (PUCCH) may carry uplink control information. Simultaneous transmission of PUCCH and PUSCH from the same UE may be supported if enabled by higher layers. For a type 2 frame structure, the PUCCH may not be transmitted in the UpPTS field. PUCCH may use one resource block in each of the two slots in a subframe. Resources allocated to UE and PUCCH configuration(s) may be transmitted via control messages. PUCCH may comprise: a) positive and negative acknowledgements for data packets transmitted at least one downlink carrier, b) channel state information for at least one downlink carrier, c) scheduling request, and/or the like.

According to some of the various aspects of embodiments, cell search may be the procedure by which a wireless device may acquire time and frequency synchronization with a cell and may detect the physical layer Cell ID of that cell (transmitter). An example embodiment for synchronization signal and cell search is presented below. A cell search may support a scalable overall transmission bandwidth corresponding to 6 resource blocks and upwards. Primary and secondary synchronization signals may be transmitted in the downlink and may facilitate cell search. For example, 504 unique physical-layer cell identities may be defined using synchronization signals. The physical-layer cell identities may be grouped into 168 unique physical-layer cell-identity groups, group(s) containing three unique identities. The grouping may be such that physical-layer cell identit(ies) is part of a physical-layer cell-identity group. A physical-layer cell identity may be defined by a number in the range of 0 to 167, representing the physical-layer cell-identity group, and a number in the range of 0 to 2, representing the physical-layer identity within the physical-layer cell-identity group. The synchronization signal may include a primary synchronization signal and a secondary synchronization signal.

According to some of the various aspects of embodiments, the sequence used for a primary synchronization signal may be generated from a frequency-domain Zadoff-Chu sequence according to a pre-defined formula. A Zadoff-Chu root sequence index may also be predefined in a specification. The mapping of the sequence to resource elements may depend on a frame structure. The wireless device may not assume that the primary synchronization signal is transmitted on the same antenna port as any of the downlink reference signals. The wireless device may not assume that any transmission instance of the primary synchronization signal is transmitted on the same antenna port, or ports, used for any other transmission instance of the primary synchronization signal. The sequence may be mapped to the resource elements according to a predefined formula.

For FDD frame structure, a primary synchronization signal may be mapped to the last OFDM symbol in slots 0 and 10. For TDD frame structure, the primary synchronization signal may be mapped to the third OFDM symbol in subframes 1 and 6. Some of the resource elements allocated to primary or secondary synchronization signals may be reserved and not used for transmission of the primary synchronization signal.

According to some of the various aspects of embodiments, the sequence used for a secondary synchronization signal may be an interleaved concatenation of two length-31 binary sequences. The concatenated sequence may be scrambled with a scrambling sequence given by a primary synchronization signal. The combination of two length-31 sequences defining the secondary synchronization signal may differ between subframe 0 and subframe 5 according to predefined formula (s). The mapping of the sequence to resource elements may depend on the frame structure. In a subframe for FDD frame structure and in a half-frame for TDD frame structure, the same antenna port as for the primary synchronization signal may be used for the secondary synchronization signal. The sequence may be mapped to resource elements according to a predefined formula.

Example embodiments for the physical channels configuration will now be presented. Other examples may also be possible. A physical broadcast channel may be scrambled with a cell-specific sequence prior to modulation, resulting in a block of scrambled bits. PBCH may be modulated using QPSK, and/or the like. The block of complex-valued symbols for antenna port(s) may be transmitted during consecutive radio frames, for example, four consecutive radio frames. In some embodiments the PBCH data may arrive to the coding unit in the form of a one transport block every transmission time interval (TTI) of 40 ms. The following coding actions may be identified. Add CRC to the transport block, channel coding, and rate matching. Error detection may be provided on PBCH transport blocks through a Cyclic Redundancy Check (CRC). The transport block may be used to calculate the CRC parity bits. The parity bits may be computed and attached to the BCH (broadcast channel) transport block. After the attachment, the CRC bits may be scrambled according to the transmitter transmit antenna configuration. Information bits may be delivered to the channel coding block and they may be tail biting convolutionally encoded. A tail biting convolutionally coded block may be delivered to the rate matching block. The coded block may be rate matched before transmission.

A master information block may be transmitted in PBCH and may include system information transmitted on broadcast channel(s). The master information block may include downlink bandwidth, system frame number(s), and PHICH (physical hybrid-ARQ indicator channel) configuration. Downlink bandwidth may be the transmission bandwidth configuration, in terms of resource blocks in a downlink, for example 6 may correspond to 6 resource blocks, 15 may correspond to 15 resource blocks and so on. System frame number(s) may define the N (for example N=8) most significant bits of the system frame number. The M (for example M=2) least significant bits of the SFN may be acquired implicitly in the PBCH decoding. For example, timing of a 40 ms PBCH TTI may indicate 2 least significant bits (within 40 ms PBCH TTI, the first radio frame: 00, the second radio frame: 01, the third radio frame: 10, the last radio frame: 11). One value may apply for other carriers in the same sector of a base station (the associated functionality is common (e.g. not performed independently for each cell). PHICH configuration(s) may include PHICH duration, which may be normal (e.g. one symbol duration) or extended (e.g. 3 symbol duration).

Physical control format indicator channel(s) (PCFICH) may carry information about the number of OFDM symbols used for transmission of PDCCHs (physical downlink control channel) in a subframe. The set of OFDM symbols possible to use for PDCCH in a subframe may depend on many parameters including, for example, downlink carrier bandwidth, in terms of downlink resource blocks. PCFICH transmitted in one subframe may be scrambled with cell-specific sequence(s) prior to modulation, resulting in a block of scrambled bits. A scrambling sequence generator(s) may be initialized at the start of subframe(s). Block (s) of scrambled bits may be modulated using QPSK. Block(s) of modulation symbols may be mapped to at least one layer and precoded resulting in a block of vectors representing the signal for at least one antenna port. Instances of PCFICH control channel(s) may indicate one of several (e.g. 3) possible values after being decoded. The range of possible values of instance(s) of the first control channel may depend on the first carrier bandwidth.

According to some of the various embodiments, physical downlink control channel(s) may carry scheduling assignments and other control information. The number of resource-elements not assigned to PCFICH or PHICH may be assigned to PDCCH. PDCCH may support multiple formats. Multiple PDCCH packets may be transmitted in a subframe. PDCCH may be coded by tail biting convolutionally encoder before transmission. PDCCH bits may be scrambled with a cell-specific sequence prior to modulation, resulting in block(s) of scrambled bits. Scrambling sequence generator(s) may be initialized at the start of subframe(s). Block(s) of scrambled bits may be modulated using QPSK. Block(s) of modulation symbols may be mapped to at least one layer and precoded resulting in a block of vectors representing the signal for at least one antenna port. PDCCH may be transmitted on the same set of antenna ports as the PBCH, wherein PBCH is a physical broadcast channel broadcasting at least one basic system information field.

According to some of the various embodiments, scheduling control packet(s) may be transmitted for packet(s) or group(s) of packets transmitted in downlink shared channel(s). Scheduling control packet(s) may include information about subcarriers used for packet transmission(s). PDCCH may also provide power control commands for uplink channels. OFDM subcarriers that are allocated for transmission of PDCCH may occupy the bandwidth of downlink carrier(s). PDCCH channel(s) may carry a plurality of downlink control packets in subframe(s). PDCCH may be transmitted on downlink carrier(s) starting from the first OFDM symbol of subframe(s), and may occupy up to multiple symbol duration(s) (e.g. 3 or 4).

According to some of the various embodiments, PHICH may carry the hybrid-ARQ (automatic repeat request) ACK/NACK. Multiple PHICHs mapped to the same set of resource elements may constitute a PHICH group, where PHICHs within the same PHICH group may be separated through different orthogonal sequences. PHICH resource(s) may be identified by the index pair (group, sequence), where group(s) may be the PHICH group number(s) and sequence(s) may be the orthogonal sequence index within the group(s). For frame structure type 1, the number of PHICH groups may depend on parameters from higher layers (RRC). For frame structure type 2, the number of PHICH groups may vary between downlink subframes according to a pre-defined arrangement. Block(s) of bits transmitted on one PHICH in one subframe may be modulated using BPSK or QPSK, resulting in a block(s) of complex-valued modulation symbols. Block(s) of modulation symbols may be symbol-wise multiplied with an orthogonal sequence and scrambled, resulting in a sequence of modulation symbols

Other arrangements for PCFICH, PHICH, PDCCH, and/or PDSCH may be supported. The configurations presented here are for example purposes. In another example, resources PCFICH, PHICH, and/or PDCCH radio resources may be transmitted in radio resources including a subset of subcarriers and pre-defined time duration in each or some of the subframes. In an example, PUSCH resource(s) may start from the first symbol. In another example embodiment, radio resource configuration(s) for PUSCH, PUCCH, and/or PRACH (physical random access channel) may use a different configuration. For example, channels may be time multiplexed, or time/frequency multiplexed when mapped to uplink radio resources.

According to some of the various aspects of embodiments, the physical layer random access preamble may comprise a cyclic prefix of length Tcp and a sequence part of length Tseq. The parameter values may be pre-defined and depend on the frame structure and a random access configuration. In an example embodiment, Tcp may be 0.1 msec, and Tseq may be 0.9 msec. Higher layers may control the preamble format. The transmission of a random access preamble, if triggered by the MAC layer, may be restricted to certain time and frequency resources. The start of a random access preamble may be aligned with the start of the corresponding uplink subframe at a wireless device.

According to an example embodiment, random access preambles may be generated from Zadoff-Chu sequences with a zero correlation zone, generated from one or several root Zadoff-Chu sequences. In another example embodiment, the preambles may also be generated using other random sequences such as Gold sequences. The network may configure the set of preamble sequences a wireless device may be allowed to use. According to some of the various aspects of embodiments, there may be a multitude of preambles (e.g. 64) available in cell(s). From the physical layer perspective, the physical layer random access procedure may include the transmission of random access preamble(s) and random access response(s). Remaining message(s) may be scheduled for transmission by a higher layer on the shared data channel and may not be considered part of the physical layer random access procedure. For example, a random access channel may occupy 6 resource blocks in a subframe or set of consecutive subframes reserved for random access preamble transmissions.

According to some of the various embodiments, the following actions may be followed for a physical random access procedure: 1) layer 1 procedure may be triggered upon request of a preamble transmission by higher layers; 2) a preamble index, a target preamble received power, a corresponding RA-RNTI (random access-radio network temporary identifier) and/or a PRACH resource may be indicated by higher layers as part of a request; 3) a preamble transmission power P_PRACH may be determined; 4) a preamble sequence may be selected from the preamble sequence set using the preamble index; 5) a single preamble may be transmitted using selected preamble sequence(s) with transmission power P_PRACH on the indicated PRACH resource; 6) detection of a PDCCH with the indicated RAR may be attempted during a window controlled by higher layers; and/or the like. If detected, the corresponding downlink shared channel transport block may be passed to higher layers. The higher layers may parse transport block(s) and/or indicate an uplink grant to the physical layer(s).

According to some of the various aspects of embodiments, a random access procedure may be initiated by a physical downlink control channel (PDCCH) order and/or by the MAC sublayer in a wireless device. If a wireless device receives a PDCCH transmission consistent with a PDCCH order masked with its radio identifier, the wireless device may initiate a random access procedure. Preamble transmission(s) on physical random access channel(s) (PRACH) may be supported on a first uplink carrier and reception of a PDCCH order may be supported on a first downlink carrier.

Before a wireless device initiates transmission of a random access preamble, it may access one or many of the following types of information: a) available set(s) of PRACH resources for the transmission of a random access preamble; b) group(s) of random access preambles and set(s) of available random access preambles in group(s); c) random access response window size(s); d) power-ramping factor(s); e) maximum number(s) of preamble transmission(s); f) initial preamble power; g) preamble format based offset(s); h) contention resolution timer(s); and/or the like. These parameters may be updated from upper layers or may be received from the base station before random access procedure(s) may be initiated.

According to some of the various aspects of embodiments, a wireless device may select a random access preamble using available information. The preamble may be signaled by a base station or the preamble may be randomly selected by the wireless device. The wireless device may determine the next available subframe containing PRACH permitted by restrictions given by the base station and the physical layer timing requirements for TDD or FDD. Subframe timing and the timing of transmitting the random access preamble may be determined based, at least in part, on synchronization signals received from the base station and/or the information received from the base station. The wireless device may proceed to the transmission of the random access preamble when it has determined the timing. The random access preamble may be transmitted on a second plurality of subcarriers on the first uplink carrier.

According to some of the various aspects of embodiments, once a random access preamble is transmitted, a wireless device may monitor the PDCCH of a first downlink carrier for random access response(s), in a random access response window. There may be a pre-known identifier in PDCCH that indentifies a random access response. The wireless device may stop monitoring for random access response(s) after successful reception of a random access response containing random access preamble identifiers that matches the transmitted random access preamble and/or a random access response address to a wireless device identifier. A base station random access response may include a time alignment command. The wireless device may process the received time alignment command and may adjust its uplink transmission timing according the time alignment value in the command. For example, in a random access response, a time alignment command may be coded using 11 bits, where an amount of the time alignment may be based on the value in the command. In an example embodiment, when an uplink transmission is required, the base station may provide the wireless device a grant for uplink transmission.

If no random access response is received within the random access response window, and/or if none of the received random access responses contains a random access preamble identifier corresponding to the transmitted random access preamble, the random access response reception may be considered unsuccessful and the wireless device may, based on the backoff parameter in the wireless device, select a random backoff time and delay the subsequent random access transmission by the backoff time, and may retransmit another random access preamble.

According to some of the various aspects of embodiments, a wireless device may transmit packets on an uplink carrier. Uplink packet transmission timing may be calculated in the wireless device using the timing of synchronization signal(s) received in a downlink. Upon reception of a timing alignment command by the wireless device, the wireless device may adjust its uplink transmission timing. The timing alignment command may indicate the change of the uplink timing relative to the current uplink timing. The uplink transmission timing for an uplink carrier may be determined using time alignment commands and/or downlink reference signals.

According to some of the various aspects of embodiments, a time alignment command may indicate timing adjustment for transmission of signals on uplink carriers. For example, a time alignment command may use 6 bits. Adjustment of the uplink timing by a positive or a negative amount indicates advancing or delaying the uplink transmission timing by a given amount respectively.

For a timing alignment command received on subframe n, the corresponding adjustment of the timing may be applied with some delay, for example, it may be applied from the beginning of subframe n+6. When the wireless device's uplink transmissions in subframe n and subframe n+1 are overlapped due to the timing adjustment, the wireless device may transmit complete subframe n and may not transmit the overlapped part of subframe n+1.

According to some of the various aspects of embodiments, a wireless device may include a configurable timer (timeAlignmentTimer) that may be used to control how long the wireless device is considered uplink time aligned. When a timing alignment command MAC control element is received, the wireless device may apply the timing alignment command and start or restart timeAlignmentTimer. The wireless device may not perform any uplink transmission except the random access preamble transmission when timeAlignmentTimer is not running or when it exceeds its limit. The time alignment command may substantially align frame and subframe reception timing of a first uplink carrier and at least one additional uplink carrier. According to some of the various aspects of embodiments, the time alignment command value range employed during a random access process may be substantially larger than the time alignment command value range during active data transmission. In an example embodiment, uplink transmission timing may be maintained on a per time alignment group (TAG) basis. Carrier(s) may be grouped in TAGs, and TAG(s) may have their own downlink timing reference, time alignment timer, and/or time alignment commands. Group(s) may have their own random access process. Time alignment commands may be directed to a time alignment group. The TAG, including the primary cell may be called a primary TAG (pTAG) and the TAG not including the primary cell may be called a secondary TAG (sTAG).

According to some of the various aspects of embodiments, control message(s) or control packet(s) may be scheduled for transmission in a physical downlink shared channel (PDSCH) and/or physical uplink shared channel PUSCH. PDSCH and PUSCH may carry control and data message(s)/packet(s). Control message(s) and/or packet(s) may be processed before transmission. For example, the control message(s) and/or packet(s) may be fragmented or multiplexed before transmission. A control message in an upper layer may be processed as a data packet in the MAC or physical layer. For example, system information block(s) as well as data traffic may be scheduled for transmission in PDSCH. Data packet(s) may be encrypted packets.

According to some of the various aspects of embodiments, data packet(s) may be encrypted before transmission to secure packet(s) from unwanted receiver(s). Desired recipient(s) may be able to decrypt the packet(s). A first plurality of data packet(s) and/or a second plurality of data packet(s) may be encrypted using an encryption key and at least one parameter that may change substantially rapidly over time. The encryption mechanism may provide a transmission that may not be easily eavesdropped by unwanted receivers. The encryption mechanism may include additional parameter(s) in an encryption module that changes substantially rapidly in time to enhance the security mechanism. Example varying parameter(s) may comprise various types of system counter(s), such as system frame number. Substantially rapidly may for example imply changing on a per subframe, frame, or group of subframes basis. Encryption may be provided by a PDCP layer between the transmitter and receiver, and/or may be provided by the application layer. Additional overhead added to packet(s) by lower layers such as RLC, MAC, and/or Physical layer may not be encrypted before transmission. In the receiver, the plurality of encrypted data packet(s) may be decrypted using a first decryption key and at least one first parameter. The plurality of data packet(s) may be decrypted using an additional parameter that changes substantially rapidly over time.

According to some of the various aspects of embodiments, a wireless device may be preconfigured with one or more carriers. When the wireless device is configured with more than one carrier, the base station and/or wireless device may activate and/or deactivate the configured carriers. One of the carriers (the primary carrier) may always be activated. Other carriers may be deactivated by default and/or may be activated by a base station when needed. A base station may activate and deactivate carriers by sending an activation/deactivation MAC control element. Furthermore, the UE may maintain a carrier deactivation timer per configured carrier and deactivate the associated carrier upon its expiry. The same initial timer value may apply to instance(s) of the carrier deactivation timer. The initial value of the timer may be configured by a network. The configured carriers (unless the primary carrier) may be initially deactivated upon addition and after a handover.

According to some of the various aspects of embodiments, if a wireless device receives an activation/deactivation MAC control element activating the carrier, the wireless device may activate the carrier, and/or may apply normal carrier operation including: sounding reference signal transmissions on the carrier, CQI (channel quality indicator)/PMI (precoding matrix indicator)/RI (ranking indicator) reporting for the carrier, PDCCH monitoring on the carrier, PDCCH monitoring for the carrier, start or restart the carrier deactivation timer associated with the carrier, and/or the like. If the device receives an activation/deactivation MAC control element deactivating the carrier, and/or if the carrier deactivation timer associated with the activated carrier expires, the base station or device may deactivate the carrier, and may stop the carrier deactivation timer associated with the carrier, and/or may flush HARQ buffers associated with the carrier.

If PDCCH on a carrier scheduling the activated carrier indicates an uplink grant or a downlink assignment for the activated carrier, the device may restart the carrier deactivation timer associated with the carrier. When a carrier is deactivated, the wireless device may not transmit SRS (sounding reference signal) for the carrier, may not report CQI/PMI/RI for the carrier, may not transmit on UL-SCH for the carrier, may not monitor the PDCCH on the carrier, and/or may not monitor the PDCCH for the carrier.

A process to assign subcarriers to data packets may be executed by a MAC layer scheduler. The decision on assigning subcarriers to a packet may be made based on data packet size, resources required for transmission of data packets (number of radio resource blocks), modulation and coding assigned to data packet(s), QoS required by the data packets (i.e. QoS parameters assigned to data packet bearer), the service class of a subscriber receiving the data packet, or subscriber device capability, a combination of the above, and/or the like.

According to some of the various aspects of embodiments, packets may be referred to service data units and/or protocols data units at Layer 1, Layer 2 and/or Layer 3 of the communications network. Layer 2 in an LTE network may include three sub-layers: PDCP sub-layer, RLC sub-layer, and MAC sub-layer. A layer 2 packet may be a PDCP packet, an RLC packet or a MAC layer packet. Layer 3 in an LTE network may be Internet Protocol (IP) layer, and a layer 3 packet may be an IP data packet. Packets may be transmitted and received via an air interface physical layer. A packet at the physical layer may be called a transport block. Many of the various embodiments may be implemented at one or many different communication network layers. For example, some of the actions may be executed by the PDCP layer and some others by the MAC layer.

According to some of the various aspects of embodiments, subcarriers and/or resource blocks may comprise a plurality of physical subcarriers and/or resource blocks. In another example embodiment, subcarriers may be a plurality of virtual and/or logical subcarriers and/or resource blocks.

According to some of the various aspects of embodiments, a radio bearer may be a GBR (guaranteed bit rate) bearer and/or a non-GBR bearer. A GBR and/or guaranteed bit rate bearer may be employed for transfer of real-time packets, and/or a non-GBR bearer may be used for transfer of non-real-time packets. The non-GBR bearer may be assigned a plurality of attributes including: a scheduling priority, an allocation and retention priority, a portable device aggregate maximum bit rate, and/or the like. These parameters may be used by the scheduler in scheduling non-GBR packets. GBR bearers may be assigned attributes such as delay, jitter, packet loss parameters, and/or the like.

According to some of the various aspects of embodiments, subcarriers may include data subcarrier symbols and pilot subcarrier symbols. Pilot symbols may not carry user data, and may be included in the transmission to help the receiver to perform synchronization, channel estimation and/or signal quality detection. Base stations and wireless devices (wireless receiver) may use different methods to generate and transmit pilot symbols along with information symbols.

According to some of the various aspects of embodiments, the transmitter in the disclosed embodiments of the present invention may be a wireless device (also called user equipment), a base station (also called eNodeB), a relay node transmitter, and/or the like. The receiver in the disclosed embodiments of the present invention may be a wireless device (also called user equipment-UE), a base station (also called eNodeB), a relay node receiver, and/or the like. According to some of the various aspects of embodiments of the present invention, layer 1 (physical layer) may be based on OFDMA or SC-FDMA. Time may be divided into frame(s) with fixed duration. Frame(s) may be divided into substantially equally sized subframes, and subframe(s) may be divided into substantially equally sized slot(s). A plurality of OFDM or SC-FDMA symbol(s) may be transmitted in slot(s). OFDMA or SC-FDMA symbol(s) may be grouped into resource block(s). A scheduler may assign resource(s) in resource block unit(s), and/or a group of resource block unit(s). Physical resource block(s) may be resources in the physical layer, and logical resource block(s) may be resource block(s) used by the MAC layer. Similar to virtual and physical subcarriers, resource block(s) may be mapped from logical to physical resource block(s). Logical resource block(s) may be contiguous, but corresponding physical resource block(s) may be non-contiguous. Some of the various embodiments of the present invention may be implemented at the physical or logical resource block level(s).

According to some of the various aspects of embodiments, layer 2 transmission may include PDCP (packet data convergence protocol), RLC (radio link control), MAC (media access control) sub-layers, and/or the like. MAC may be responsible for the multiplexing and mapping of logical channels to transport channels and vice versa. A MAC layer may perform channel mapping, scheduling, random access channel procedures, uplink timing maintenance, and/or the like.

According to some of the various aspects of embodiments, the MAC layer may map logical channel(s) carrying RLC PDUs (packet data unit) to transport channel(s). For transmission, multiple SDUs (service data unit) from logical channel(s) may be mapped to the Transport Block (TB) to be sent over transport channel(s). For reception, TBs from transport channel(s) may be demultiplexed and assigned to corresponding logical channel(s). The MAC layer may perform scheduling related function(s) in both the uplink and downlink and thus may be responsible for transport format selection associated with transport channel(s). This may include HARQ functionality. Since scheduling may be done at the base station, the MAC layer may be responsible for reporting scheduling related information such as UE (user equipment or wireless device) buffer occupancy and power headroom. It may also handle prioritization from both an inter-UE and intra-UE logical channel perspective. MAC may also be responsible for random access procedure(s) for the uplink that may be performed following either a contention and non-contention based process. UE may need to maintain timing synchronization with cell(s). The MAC layer may perform procedure(s) for periodic synchronization.

According to some of the various aspects of embodiments, the MAC layer may be responsible for the mapping of multiple logical channel(s) to transport channel(s) during transmission(s), and demultiplexing and mapping of transport channel data to logical channel(s) during reception. A MAC PDU may include of a header that describes the format of the PDU itself, which may include control element(s), SDUs, Padding, and/or the like. The header may be composed of multiple sub-headers, one for constituent part(s) of the MAC PDU. The MAC may also operate in a transparent mode, where no header may be pre-pended to the PDU. Activation command(s) may be inserted into packet(s) using a MAC control element.

According to some of the various aspects of embodiments, the MAC layer in some wireless device(s) may report buffer size(s) of either a single Logical Channel Group (LCG) or a group of LCGs to a base station. An LCG may be a group of logical channels identified by an LCG ID. The mapping of logical channel(s) to LCG may be set up during radio configuration. Buffer status report(s) may be used by a MAC scheduler to assign radio resources for packet transmission from wireless device(s). HARQ and ARQ processes may be used for packet retransmission to enhance the reliability of radio transmission and reduce the overall probability of packet loss.

According to some of the various aspects of embodiments, an RLC sub-layer may control the applicability and functionality of error correction, concatenation, segmentation, re-segmentation, duplicate detection, in-sequence delivery, and/or the like. Other functions of RLC may include protocol error detection and recovery, and/or SDU discard. The RLC sub-layer may receive data from upper layer radio bearer(s) (signaling and data) called service data unit(s) (SDU). The transmission entities in the RLC layer may convert RLC SDUs to RLC PDU after performing functions such as segmentation, concatenation, adding RLC header(s), and/or the like. In the other direction, receiving entities may receive RLC PDUs from the MAC layer. After performing reordering, the PDUs may be assembled back into RLC SDUs and delivered to the upper layer. RLC interaction with a MAC layer may include: a) data transfer for uplink and downlink through logical channel(s); b) MAC notifies RLC when a transmission opportunity becomes available, including the size of total number of RLC PDUs that may be transmitted in the current transmission opportunity, and/or c) the MAC entity at the transmitter may inform RLC at the transmitter of HARQ transmission failure.

According to some of the various aspects of embodiments, PDCP (packet data convergence protocol) may comprise a layer 2 sub-layer on top of RLC sub-layer. The PDCP may be responsible for a multitude of functions. First, the PDCP layer may transfer user plane and control plane data to and from upper layer(s). PDCP layer may receive SDUs from upper layer(s) and may send PDUs to the lower layer(s). In other direction, PDCP layer may receive PDUs from the lower layer(s) and may send SDUs to upper layer(s). Second, the PDCP may be responsible for security functions. It may apply ciphering (encryption) for user and control plane bearers, if configured. It may also perform integrity protection for control plane bearer(s), if configured. Third, the PDCP may perform header compression service(s) to improve the efficiency of over the air transmission. The header compression may be based on robust header compression (ROHC). ROHC may be performed on VoIP packets. Fourth, the PDCP may be responsible for in-order delivery of packet(s) and duplicate detection service(s) to upper layer(s) after handover(s). After handover, the source base station may transfer unacknowledged packet(s)s to target base station when operating in RLC acknowledged mode (AM). The target base station may forward packet(s)s received from the source base station to the UE (user equipment).

In this specification, “a” and “an” and similar phrases are to be interpreted as “at least one” and “one or more.” In this specification, the term “may” is to be interpreted as “may, for example,” In other words, the term “may” is indicative that the phrase following the term “may” is an example of one of a multitude of suitable possibilities that may, or may not, be employed to one or more of the various embodiments.

Many of the elements described in the disclosed embodiments may be implemented as modules. A module is defined here as an isolatable element that performs a defined function and has a defined interface to other elements. The modules described in this disclosure may be implemented in hardware, software in combination with hardware, firmware, wetware (i.e hardware with a biological element) or a combination thereof, all of which are behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. Additionally, it may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) using FDD communication systems. However, one skilled in the art will recognize that embodiments of the invention may also be implemented in TDD communication systems. The disclosed methods and systems may be implemented in wireless or wireline systems. The features of various embodiments presented in this invention may be combined. One or many features (method or system) of one embodiment may be implemented in other embodiments. Only a limited number of example combinations are shown to indicate to one skilled in the art the possibility of features that may be combined in various embodiments to create enhanced transmission and reception systems and methods.

In addition, it should be understood that any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method comprising:
a) storing, in a base station configured to communicate employing a plurality of carriers, for an RRC-connected wireless device:
i) an identity of a primary carrier in said plurality of carriers, each of said plurality of carriers comprises a plurality of OFDM subcarriers;
ii) an identity of each of at least one secondary carrier in said plurality of carriers; and
iii) an activation status of each of said at least one secondary carrier;
b) transmitting, by said base station, an RRC reconfiguration message to said RRC-connected wireless device using a first plurality of OFDM subcarriers in said plurality of OFDM subcarriers, said RRC reconfiguration message configuring at least one new secondary carrier in said at least one secondary carrier for said RRC-connected wireless device, said RRC reconfiguration message comprising:
i) said identity of each of said at least one new secondary carrier;
ii) configuration information about said at least one new secondary carrier; and
iii) an activation status field of each of said at least one new secondary carrier, said activation status field:
(1) having an active or inactive status for each of said at least one new secondary carrier; and
(2) configured to cause said RRC-connected wireless device to control the activation of each of said at least one new secondary carrier according to said activation status field;
c) receiving, by said base station, an RRC reconfiguration complete message from said RRC-connected wireless device indicating that said RRC reconfiguration message is received by said RRC-connected wireless device;
d) transmitting, by said base station, a plurality of data packets to said RRC-connected wireless device on a data channel that at least employs a second plurality of OFDM subcarriers of at least one of said at least one new secondary carrier; and
e) changing, by said base station, said activation status of an active carrier in said at least one secondary carrier from an active state to an inactive state after an associated deactivation timer of said active carrier of said RRC-connected wireless device expires.

2. The method of claim 1, further comprising restarting said deactivation timer associated with said active carrier when a packet in said plurality of data packets is transmitted on said active carrier in said at least one secondary carrier.

3. The method of claim 1, further comprising transmitting a scheduling control packet before each data packet in said plurality of data packets is transmitted, said scheduling control packet comprising information about the subcarriers employed in transmitting the corresponding data packet.

4. The method of claim 1, wherein both said RRC reconfiguration message and RRC reconfiguration complete message are:
a) encrypted; and
b) protected by an integrity header.

5. The method of claim 1, wherein said RRC reconfiguration message is configured to cause at least one radio bearer to be setup or modified.

6. The method of claim 1, wherein said RRC reconfiguration message is configured to cause at least one parameter of a MAC layer or a physical layer to be configured.

7. The method of claim 1, wherein transmission time is divided into a plurality of subframes, and the subframe transmission timing of said at least one secondary carrier is synchronized with the subframe transmission timing of said primary carrier.

8. The method of claim 1, wherein said RRC reconfiguration message is an LTE-advanced technology RRC Connection Reconfiguration message that includes at least one of the following:
a) measurement configuration information; and
b) an RRC transaction identifier.

9. The method of claim 1, wherein said RRC reconfiguration message is configured to cause an RRC connection to be configured.

10. The method of claim 1, wherein said RRC reconfiguration complete message comprises an RRC transaction identifier.

11. A wireless device comprising:
a) one or more communication interfaces;
b) one or more processors; and
c) memory storing instructions that, when executed, cause said wireless device to:
i) receive an RRC reconfiguration message from a base station using a first plurality of OFDM subcarriers in said plurality of OFDM subcarriers, said RRC reconfiguration message configuring at least one new secondary carrier for said wireless device, said RRC reconfiguration message comprising:
(1) said identity of each of said at least one new secondary carrier;
(2) configuration information about said at least one new secondary carrier; and
(3) an activation status field of each of said at least one new secondary carrier, said activation status field:
(a) having an active or inactive status for each of said at least one new secondary carrier; and
(b) configured to cause said wireless device to control the activation of each of said at least one new secondary carrier according to said activation status field;
ii) transmit an RRC reconfiguration complete message to said base station indicating that said RRC reconfiguration message is received by said wireless device;
iii) receive a plurality of data packets from said base station on a data channel that at least employs a second plurality of OFDM subcarriers of at least one of said at least one new secondary carrier; and
iv) change said activation status of an active carrier in said at least one secondary carrier from an active state to an inactive state after an associated deactivation timer of said active carrier of said wireless device expires.

12. The wireless device of claim 11, wherein said wireless device deactivates said at least one new secondary carrier if said associated deactivation timer expires after a last packet in said plurality of data packets received over said at least one new secondary carrier.

13. The wireless device of claim 12, wherein when said at least one new secondary carrier is deactivated, said wireless device does not process the corresponding PDCCH or PDSCH.

14. The wireless device of claim 12, wherein when said at least one new secondary carrier is deactivated, said wireless device does not transmit in a corresponding uplink.

15. The wireless device of claim 12, wherein after said at least one new secondary carrier is deactivated, said wireless device is not required to perform CQI measurements for said at least one new secondary carrier.

16. The wireless device of claim 11, wherein when one of said at least one new secondary carrier is activated, said wireless device is configured to process signals received from said one of said at least one new secondary carrier.

17. The wireless device of claim 11, wherein said RRC reconfiguration complete message further indicates that said RRC reconfiguration message is successfully processed by said wireless device.

18. A method comprising:
a) storing, in a base station configured to communicate employing a plurality of carriers, for an RRC-connected wireless device:
i) an identity of a primary carrier in said plurality of carriers, each of said plurality of carriers comprises a plurality of OFDM subcarriers;
ii) an identity of each of at least one secondary carrier in said plurality of carriers; and
iii) an activation status of each of said at least one secondary carrier;
b) transmitting, by said base station, an RRC reconfiguration message to said RRC-connected wireless device using a first plurality of OFDM subcarriers in said plurality of OFDM subcarriers, said RRC reconfiguration message configuring at least one new secondary carrier in said at least one secondary carrier for said RRC-connected wireless device, said RRC reconfiguration message comprising:
i) said identity of each of said at least one new secondary carrier; and
ii) configuration information about said at least one new secondary carrier; said RRC-connected wireless device activating said at least one new secondary carrier after said RRC reconfiguration message is successfully processed by said RRC-connected wireless device;
c) receiving, by said base station, an RRC reconfiguration complete message from said RRC-connected wireless device indicating that said RRC reconfiguration message is received by said RRC-connected wireless device;
d) transmitting, by said base station, a plurality of data packets to said RRC-connected wireless device on a data channel that at least employs a second plurality of OFDM subcarriers of at least one of said at least one new secondary carrier; and
e) changing, by said base station, said activation status of an active carrier in said at least one secondary carrier from an active state to an inactive state after an associated deactivation timer of said active carrier of said RRC-connected wireless device expires.

19. The method of claim 18, wherein both said RRC reconfiguration message and RRC reconfiguration complete message are:
a) encrypted; and
b) protected by an integrity header.

20. The method of claim 18, wherein said RRC reconfiguration complete message comprises an RRC transaction identifier.
